(19) United States
(12) Patent Application Publication
(10) Pub. No.: US 2013/0148384 A1
(43) Pub. Date: Jun. 13, 2013

(54) INTEGRATED RESONANCE AND POWER FACTOR CORRECTION CONTROL INTEGRATED CIRCUIT AND POWER CONVERTER

(71) Applicant: Samsung Electro-Mechanics Co., Ltd., Gyeonggi-do (KR)

(72) Inventors: Byung Hoon Kim, Gyeonggi-do (KR); Byung Ram Choi, Seoul (KR); Jeong Mo Yang, Gyeonggi-do (KR); Jae Shin Lee, Gyeonggi-do (KR); Dae Hoon Han, Gyeonggi-do (KR); Yu Jin Jang, Gyeonggi-do (KR)

(73) Assignee: SAMSUNG ELECTRO-MECHANICS CO., LTD., Gyeonggi-do (KR)

(21) Appl. No.: 13/707,536

(22) Filed: Dec. 6, 2012

(30) Foreign Application Priority Data
Dec. 7, 2011 (KR) 10-2011-0130379

(51) Int. Cl. H02M 3/335

(52) U.S. Cl. CPC H02M 3/33507
USPC 363/21.02

(57) ABSTRACT

Provided are a resonance and PFC integrated control IC and a power converter. The resonance and PFC integrated control IC includes an interleave PFC control block and a resonance control block. The interleave PFC control block is configured to control first and second switches of an interleave switching converter and correct a power factor. The interleave switching converter includes a first converter comprising the first switch and a second converter comprising the second switch, and the first converter and the second converter are connected in parallel. The resonance control block is configured to resonate and control a Direct Current (DC)-DC converter that receives and converts the output of the interleave switching converter.

### CROSS-REFERENCE TO RELATED APPLICATIONS

This application claims the benefit of Korean Patent Application No. 10-2011-0130379 filed with the Korea Intellectual Property Office on Dec. 7, 2011, the disclosure of which is incorporated herein by reference.

### BACKGROUND OF THE INVENTION

1. Field of the Invention

The present invention relates to A resonance and Power Factor Correction (PFC) integrated control Integrated Circuit (IC) and a power converter, and more particularly, to an improved resonance and PFC integrated control IC and an improved power converter.

2. Description of the Related Art

In general, a full-wave rectifying diode and a smoothing capacitor are essential components of a Switching-Mode Power Supply (SMPS). In this case, a low power factor of about 0.6 is caused by a harmonic distortion and a peak current that are generated in the full-wave rectifying diode and the smoothing capacitor. A Power Factor Correction (PFC) circuit is installed to prevent this.

A PFC circuit corrects such a low power factor to about ‘1’, thereby making it possible to reduce a harmonic distortion in a power line and obtain the maximum active power from input power. The PFC circuit controls power supplied to component parts such as a converter, a stabilizer, and a transformer that are at risk of an instantaneous power leakage, thus making it possible to supply a stable current to each part and prevent unnecessary power consumption.

An interleave PFC circuit includes a master converter and a slave converter that are alternately switched with a phase difference of 180° and corrects a power factor.

Power semiconductor elements such as transistors, MOSFETs, IGBTs, SCRs, GTOs, and diodes are used as converter switches. These power semiconductor elements are not ideal, thus causing a loss in an on/off switching operation. For a small-size and lightweight power supply, a converter switch should be switched at a high frequency. However, the high-frequency switching increases a switching loss. A resonant converter may have high efficiency even at a high frequency because it can minimize a switching loss by causing the voltage or current of a switch to be zero at the moment of switching.

In a resonant converter, two switches are alternately turned off. In the resonant converter, resonance occurs between a capacitor and the leakage inductance and magnetizing inductance component of a transformer having a primary coil and a secondary coil, and a current is generated by the resonance.

Conventionally, an interleave PFC control IC and a resonance control IC for a resonant converter have been separately developed and packaged on a board. When the ICs are packaged separately, the interconnection thereof is vulnerable to a noise. Also, the cost of packaging increases, and the package size is difficult to reduce. Also, the separation of signal lines causes the problem of interference.

### SUMMARY OF THE INVENTION

The present invention has been invented in order to overcome the above-described problems and it is, therefore, an object of the present invention to integrate an interleave PFC circuit and a resonant converter control circuit into one chip, thus reducing the number of parts, cutting costs, and reducing the product size.

In accordance with one aspect of the present invention to achieve the object, there is provided a resonance and PFC integrated control IC, which includes: an interleave PFC control block configured to control first and second switches of an interleave switching converter and correct a power factor, wherein the interleave switching converter includes a first converter including the first switch and a second converter including the second switch, and the first converter and the second converter are connected in parallel; and a resonance control block configured to resonate and control a DC-DC converter that receives and converts the output of the interleave switching converter.

The interleave PFC control block may include: a PFC driving unit configured to drive the first and second switches; a zero-cross detecting unit configured to detect a zero-cross of power flowing in a first inductor of the first converter and a second inductor of the second converter; an interleave signal generating unit configured to receive the output of the zero-cross detecting unit and generate an interleave signal to allow the PFC driving unit to control the first and second switches; and a Pulse Width Modulation (PWM) control signal generating unit configured to receive a feedback of the output of the interleave switching converter, determine a PWM duty ratio, and provide the determined PWM duty ratio to the PFC driving unit.

The PWM control signal generating unit may include: an error amplifier configured to compare the feedback signal of the output of the interleave switching converter with a reference voltage signal and amplify an error therebetween; a PWM comparator configured to compare an amplified signal of the error amplifier with a reference waveform and output an on-time or off-time duty; and a sequential circuit configured to receive the output of the PWM comparator and the output of the interleave signal generating unit and provide a PWM control signal to the PFC driving unit.

The interleave PFC control block may further include an abnormal state detecting unit configured to detect an abnormal state of the IC or the interleave switching converter. The PWM control signal generating unit may further include an OR gate configured to receive the output of the PWM comparator and the output of the abnormal state detecting unit and output the result to the sequential circuit.

The resonance and PFC integrated control IC may further include a power supply block including: a power supply unit configured to supply an internal reference voltage; and an Under-Voltage Lock-Out (UVLO) unit configured to interrupt a low-voltage input of the internal reference voltage.

The resonance control block may include: a resonant driving unit configured to control an alternate switching of third and fourth switches of the DC-DC converter to input the output of the interleave switching converter into a transformer at a resonant frequency; and a switching control signal generating unit configured to receive a feedback of the output of the DC-DC converter and provide a switching control signal to the resonant driving unit.

The resonance control block may further include a soft start circuit unit configured to generate and provide a soft start signal to the resonant driving unit when the DC-DC converter is in an abnormal state.

In accordance with another aspect of the present invention to achieve the object, there is provided a power converter, which includes: a bridge rectifier configured to rectify an Alternating Current (AC) input; an interleave switching converter configured to convert the output of the bridge rectifier into a Direct Current (DC) voltage by first and second converters, wherein the interleave switching converter may include the first converter including a first switch and the second converter including a second switch, and the first converter and the second converter are connected in parallel; a DC-DC converter including third and fourth switches configured to receive the DC voltage output of the interleave switching converter, perform alternate switching, and output the result at a resonant frequency, and a transformer configured to convert the output signal of the third and fourth switches into a DC signal; and a resonance and PFC integrated control IC including an interleave PFC control block configured to control the first and second switches of the interleave switching converter and correct a power factor, and a resonance control block configured to control the third and fourth switches of the DC-DC converter to be alternately switched at a resonant frequency.

The interleave PFC control block of the resonance and PFC integrated control IC may include: a PFC driving unit configured to drive the first and second switches; a zero-cross detecting unit configured to detect a zero-cross of power flowing in a first inductor of the first converter and a second inductor of the second converter; an interleave signal generating unit configured to receive the output of the zero-cross detecting unit and generate an interleave signal to allow the PFC driving unit to control the first and second switches; and a Pulse Width Modulation (PWM) control signal generating unit configured to receive a feedback of the output of the interleave switching converter, determine a PWM duty ratio, and provide the determined PWM duty ratio to the PFC driving unit.

The resonance control block of the resonance and PFC integrated control IC may include: a resonant driving unit configured to control an alternate switching of third and fourth switches of the DC-DC converter to input the output of the interleave switching converter into a transformer at a resonant frequency; and a switching control signal generating unit configured to receive a feedback of the output of the DC-DC converter and provide a switching control signal to the resonant driving unit.

The interleave switching converter may be a boost converter.

The output unit of the interleave switching converter may include an overvoltage protection circuit configured to interrupt the application of an internal reference voltage of the resonance and PFC integrated control IC when an output voltage is higher than a predetermined voltage.

The output unit of the interleave switching converter may include a discharge circuit configured to discharge a charged voltage of an output capacitor when an internal reference voltage of the resonance and PFC integrated control IC is off.

The DC-DC converter may be a resonant LLC converter.

The DC-DC converter may include a switching unit including the third and fourth switches. The switching unit may include a switching transformer configured to receive a control signal of the resonance control block of the resonance and PFC integrated control IC at a primary side thereof, provide an output to the third switch as a first secondary output, and provide an output to the fourth switch as a second secondary output having the opposite phase to the first secondary output.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a circuit diagram illustrating a resonance and PFC integrated control IC in accordance with an exemplary embodiment of the present invention;

FIG. 2 is a circuit diagram illustrating a power converter in accordance with an exemplary embodiment of the present invention; and

FIG. 3 is a circuit diagram illustrating a power converter in accordance with another exemplary embodiment of the present invention.

### DETAILED DESCRIPTION OF THE PREFERABLE EMBODIMENTS

Hereinafter, specific embodiments of the present invention will be described with reference to the accompanying drawings. However, the present invention is provided for the illustrative purpose only but not limited thereto.

This invention may be embodied in different forms and should not be construed as limited to the embodiments set forth herein. Rather, these embodiments are provided so that this disclosure will be thorough and complete, and will fully convey the scope of the invention to those skilled in the art.

Exemplary embodiments of the present invention for achieving the above objects will be described with reference to the accompanying drawings. In the specification, like reference numerals denote like elements, and duplicate or redundant descriptions will be omitted for conciseness.

It will be understood that when an element is referred to as being ‘connected to’ or ‘coupled to’ another element, it may be directly connected or coupled to the other element or at least one intervening element may be present therebetween. In contrast, when an element is referred to as being ‘directly connected to’ or ‘directly coupled to’ another element, there are no intervening element therebetween. Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features.

It should be noted that the singular forms ‘a’ ‘an’ and ‘the’ are intended to include the plural forms as well, unless the context clearly indicates otherwise. It should be understood that the terms ‘comprise’, ‘include’ and ‘have’, when used in this specification, specify the presence of stated features or elements, but do not preclude the presence or addition of one or more other features, elements, or combinations thereof.

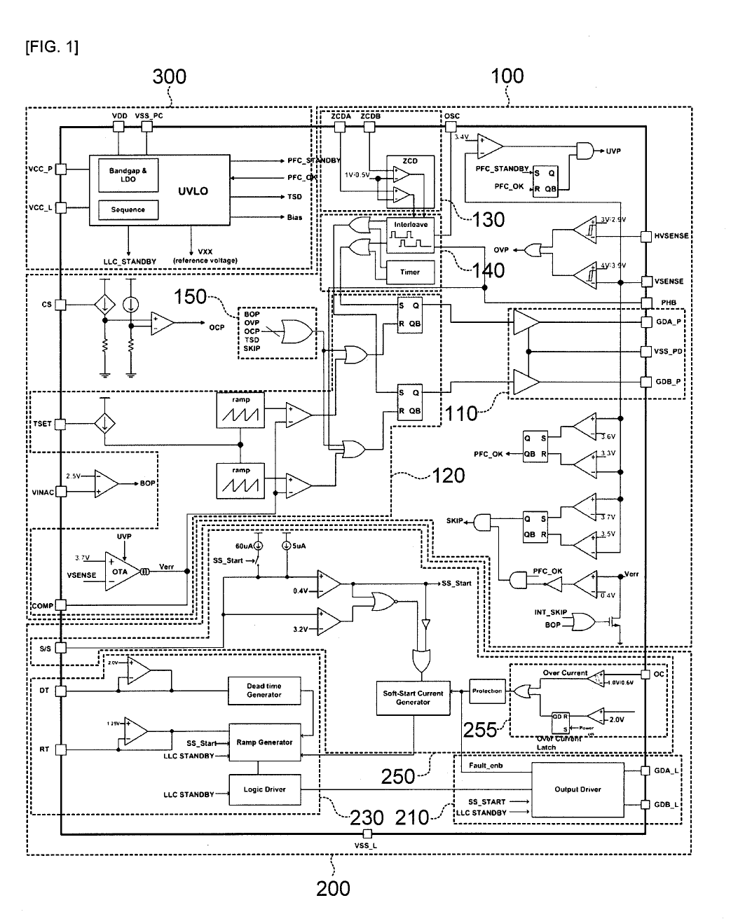

A resonance and PFC integrated control IC in accordance with an exemplary embodiment of the present invention will be described below in detail with reference to FIG. 1 and FIGS. 2 and 3. In the drawings, like reference numerals denote like elements.

FIG. 1 is a circuit diagram illustrating a resonance and PFC integrated control IC in accordance with an exemplary embodiment of the present invention.

Referring to FIG. 1, a resonance and PFC integrated control IC in accordance with an exemplary embodiment of the present invention includes a PFC control block 110 and a resonance control block 200.

In an exemplary embodiment, the resonance and PFC integrated control IC may further include a power supply block 300 that includes a power supply unit configured to supply an internal reference voltage and an Under-Voltage Lock-Out (UVLO) unit configured to interrupt a low-voltage input of the internal reference voltage.

First, the interleave PFC control block 100 will be described below in detail with reference to FIG. 1.

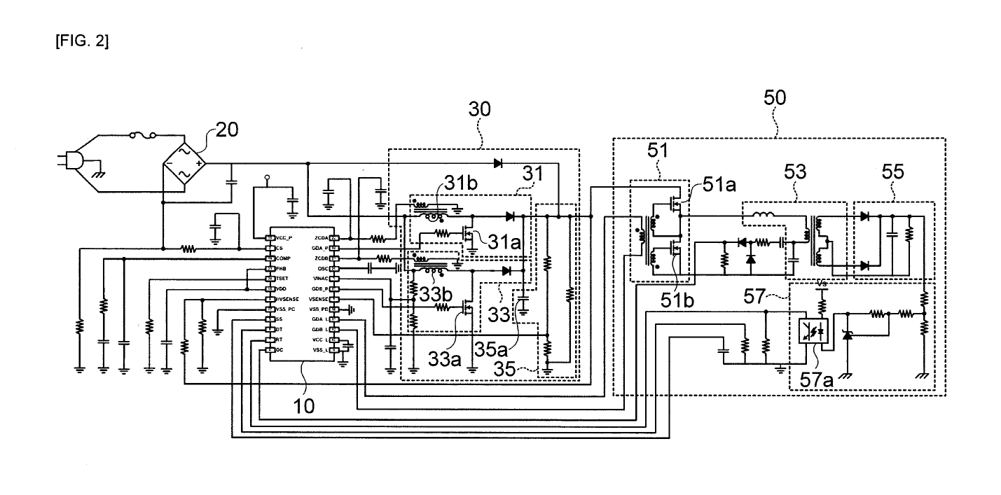

Referring to FIGS. 1 and 2, the interleave PFC control block 100 is configured to control first and second switches 31a and 33a of an interleave switching converter 30 and correct a power factor. Herein, the interleave switching converter 30 includes a first converter 31 including the first switch 31a and a second converter 33 including the second switch 33a, and the first converter 31 and the second converter 33 are connected in parallel. The interleave switching converter 30 may be a boost converter. Also, the first converter 31 of the interleave switching converter 30 may be a master converter, and the second converter 33 may be a slave converter.

Referring to FIG. 1, in an exemplary embodiment, the interleave PFC control block 100 may include a PFC driving unit 110, a zero-cross detecting unit 130, an interleave signal generating unit 140, and a Pulse Width Modulation (PWM) control signal generating unit 120.

The PFC driving unit 110 may be configured to drive the first and second switches 31a and 33a of the interleave switching converter 30. In FIG. 1, the PFC driving unit 110 may control the first switch 31a of the first converter 31 through a GDA_P terminal, and control the second switch 33a of the second converter 33 through a GDB_P terminal. The first and second switches 31a and 33a controlled by the PFC driving unit 110 may be NMOS transistors.

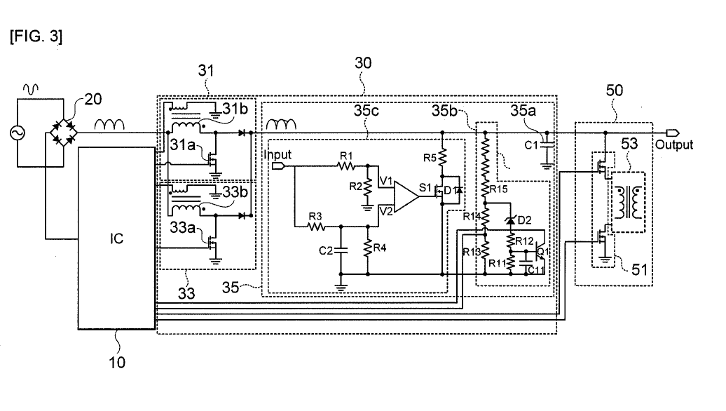

Referring to FIGS. 1 and 2, the zero-cross detecting unit 130 of the interleave PFC control bock 100 may be configured to detect a zero-cross of power flowing in a first inductor 31b of the first converter 31 and a second inductor 33b of the second converter 33. The zero-cross detecting unit 130 may detect a zero-cross of a voltage or a current power flowing in the first inductor 31b and the second inductor 33b. As illustrated in FIG. 2 and/or FIG. 3, a Zero-Cross Transformer (ZCT) may be installed at each of the first and second inductors 31b and 33b to detect a zero-cross of an induced current. Referring to FIG. 2, terminals ZCDA and ZCDB of the zero-cross detecting unit 130 are connected respectively to the ZCTs of the first and second inductors 31b and 33b. The detected signals inputted through the terminals ZCDA and ZCDB are inputted into a comparator together with a predetermined low-voltage signal, and a zero-cross thereof is detected by the comparator. For example, a high signal is applied to the interleave signal generating unit 140 when the zero-cross is detected by the zero-cross detecting unit 130.

Referring to FIG. 1, the interleave signal generating unit 140 of the interleave PFC control block 100 may be configured to receive the output of the zero-cross detecting unit 130 and generate an interleave signal to allow the PFC driving unit 110 to control the first and second switches 31a and 33a. Referring to FIG. 1, the generated interleave signal is inputted into a sequential circuit (e.g., a flip-flop circuit or a latch circuit) of the PWM control signal generating unit 120, and the sequential circuit outputs a signal to the PFC driving unit 110 according to a combination of signals. Referring to FIG. 1, the interleave signal is generated as a pulse wave from the output of the zero-cross detecting unit 130 and an oscillation signal of an oscillator. The pulse wave is inputted into a logic circuit (e.g., an OR gate) together with a timer signal, and it is inputted as a set input signal into a sequential circuit of FIG. 1 (e.g., a flip-flop circuit or a latch circuit). Also, because the first converter 31 and the second converter 33 have the opposite phases, the interleave signals forming the control signals applied respectively to the first and second switches 31a and 33a are also provided with the opposite phases. To this end, for example, an phase inversion signal is received from a PHB terminal to generate an interleave signal forming a signal applied to the second switch 33a. For example, a phase inversion signal is received to cause the second switch 33a to be off-time when the first switch 31a is on-time.

Referring to FIG. 1, the PWM control signal generating unit 120 of the interleave PFC control block 100 may be configured to receive a feedback of the output of the interleave switching converter 30, determine a PWM duty ratio, and provide the determined PWM duty ratio to the PFC driving unit 110.

In an exemplary embodiment, the PWM control signal generating unit 120 may include an error amplifier OTA, a PWM comparator, and a sequential circuit.

Referring to FIG. 1, the error amplifier OTA may be configured to compare a feedback signal of the output of the interleave switching converter 30 with a reference voltage signal and amplify an error therebetween. Herein, the feedback signal of the output of the interleave switching converter 30 is inputted through a VSENSE terminal. Referring to FIG. 2, an output resistance is divided by an output unit 35 of the interleave switching converter 30, and it is inputted to a feedback signal VSENSE terminal. In FIG. 1, for example, the error amplifier OTA receives a feedback signal of the output of the interleave switching converter 30 through an inverting terminal, receives a reference voltage signal of 3.7 V through a noninverting terminal, amplifies an error therebetween, and outputs an error amplification signal Verr. In FIG. 1, the other divided output of the error amplifier OTA is connected to a COMP terminal.

Referring to FIG. 1, the PWM comparator may be configured to compare an amplified signal of the error amplifier OTA with a reference waveform and determine and output an on-time or off-time duty. Referring to FIG. 1, the PWM comparator receives an error amplification signal Verr outputted from the error amplifier OTA and a reference waveform (e.g., a ramp wave, a sawtooth wave, or a triangle wave), adjusts an on-time or off-time period of a PWM control signal, and determines and outputs a duty. In FIG. 1, the error amplification signal Verr is inputted to an inverting terminal of the PWM comparator, the ramp signal (i.e., the reference waveform) is inputted to a noninverting terminal, the on-time duty of the PWM control signal is adjusted, and the duty is determined.

Referring to FIG. 1, the sequential circuit may be configured to receive the output of the PWM comparator and the output of the interleave signal generating unit 140 and provide the PWM control signal to the PFC driving unit 110. The sequential circuit may be a flip-flop circuit or a latch circuit. Referring to FIG. 1, the output signal of the PWM comparator is inputted through an OR gate to a reset terminal of an SR flip-flop (i.e., a sequential circuit), the output of the interleave signal generating unit 140 is inputted to a set terminal, and the PWM control signal is outputted from an output terminal Q to the PFC driving unit 110.

Referring to FIG. 1, in an exemplary embodiment, the sequential circuit may receive the output of the PWM comparator not directly but through a logic circuit such as an OR gate.

Referring to FIG. 1, in another exemplary embodiment, the interleave PFC control block 100 may further include an abnormal state detecting unit 150 configured to detect an abnormal state of a control IC 10 or an interleave switching converter 30. In FIG. 1, the abnormal state detecting unit 150 receives a SKIP signal or a protection signal of an abnormal state protection circuit (e.g., Brown-Out Protection (BOP), Over-Voltage Protection (OVP), Over-Current Protection (OCP), and Thermal Shunt-Down (TSD)) through an OR gate. In FIG. 1, the output of an OR gate of the abnormal state detecting unit 150 may be inputted to an OR gate disposed between the PWM comparator and the sequential circuit. Upon receiving the output of the OR gate of the abnormal state detecting unit 150 together with the output of the PWM comparator, the OR gate provides an output to the sequential circuit. Referring to FIG. 1, the phase inversion signal may also be inputted from the PHB terminal to the OR gate for providing a control signal to the second switch 33a, among the OR gates disposed between the PWM comparator and the sequential circuit.

The Brown-Out Protection (BOP) signal will be described. An input voltage provided to the interleave switching converter 30, for example, an input voltage connected to a front end of the second inductor 33b of the second converter 33 and divided by a resistor is inputted through a VINAC terminal, and it is compared with a predetermined voltage (e.g., 2.5 V) to output the BOP signal.

The Over-Voltage Protection (OVP) signal will be described. A comparator receives a feedback signal, which is an output division voltage of the interleave switching converter 30 inputted through a VSENSE terminal, and compares the same with a reference voltage (e.g., a 4V/3.9V voltage). Also, a comparator receives another division voltage of the output of the interleave switching converter 30 inputted through a HVENSE terminal, and compares the same with another reference voltage (e.g., a 3V/2.9V voltage). An OR gate receives an output signal of each comparator and outputs the OVP signal.

The Over-Current Protection (OCP) signal will be described. A current flowing in a bridge rectifier 20 of FIG. 2 is sensed through a CS terminal, and it is compared by a comparator to output the OCP signal.

The Thermal Shunt-Down (TSD) signal is outputted from the UVLO unit of the power supply block 300, which will be described below.

The SKIP signal will be described. An output division voltage of the interleave switching converter 30 inputted through a VSENSE terminal and a predetermined reference voltage are compared by two comparator. For example, a comparator compares the voltage with a reference voltage (e.g., 3.7 V) inputted to an inverting terminal, and another comparator compares the voltage with a reference voltage (e.g., 3.5 V) inputted to a noninverting terminal. A flip-flop or a latch (i.e., a sequential circuit) receives the resulting output signals as a set input and a reset input and outputs the result through an output terminal Q. An error amplification signal Verr is provided as a noninverting input to the error amplifier OTA, a reference signal (e.g., 0.4 V) is provided as an inverting input, and a signal is outputted from the comparator. The outputted signal is inverted by an inverter, and the result is inputted to an AND gate together with a PFC-OK signal, which will be described below. Another AND gate receives the output of the inverter, the output of the AND gate having received the PFC_OK signal, and the output of the output terminal Q, and outputs the SKIP signal.

The PFC-OK signal will be described. An output division voltage of the interleave switching converter 30 inputted through a VSENSE terminal and a predetermined reference voltage are compared by two comparator. For example, a comparator compares the voltage with a reference voltage (e.g., 3.6 V) inputted to an inverting terminal, and another comparator compares the voltage with a reference voltage (e.g., 3.3 V) inputted to a noninverting terminal. A flip-flop or a latch (i.e., a sequential circuit) receives the resulting output signals as a set input and a reset input and outputs the PFC-OK signal through an output terminal QB.

The resonance control block 200 will be described below in detail with reference to FIG. 1.

The resonance control block 200 may be configured to resonate and control a DC-DC converter 50 that receives and converts the output of the interleave switching converter 30. For example, the DC-DC converter 50 may be a resonant LLC converter.

Referring to FIG. 1, in an exemplary embodiment, the resonance control block 200 may include a resonant driving unit 210 and a switching control signal generating unit 230.

The resonant driving unit 210 of the resonance control block 200 may be configured to control an alternate switching of third and fourth switches 51a and 51b of the DC-DC converter 50 to input the output of the interleave switching converter 30 into a transformer 53 at a resonant frequency. In FIG. 1, the resonant driving unit 210 controls the third and fourth switches 51a and 51b of FIG. 2 to be alternately driven through terminals GDA_L and GDB_L. Referring to FIG. 2, the terminals GDA_L and GDB_B are connected to a primary side of a switching transformer 51c of a switching unit 51 of the DC-DC converter 50, the third switch 51a is driven according to a first output of a secondary side of the switching transformer 51c, and the fourth switch 51b is driven according to a second output of the secondary side of the switching transformer 51c, which has the opposite phase to the first output. Accordingly, the third switch 51a or the fourth switch 51b is driven according to the phase of a control signal outputted from the resonant driving unit 210. The third and fourth switches 51a and 51b may be NMOS transistors.

Referring to FIG. 1, the resonant driving unit 210 receives the output of the switching control signal generating unit 230 and controls an alternate switching of the third and fourth switches 51a and 51b of the DC-DC converter 50. Herein, the resonant driving unit 210 may also receive a soft start (SS_START) signal and a resonance standby (LLC STANDBY) signal. The resonant driving unit 210 is soft-started by the SS_START signal, and becomes a standby state according to the LLC STANDBY signal. Referring to FIG. 1, when the input from the interleave switching converter 30 to the DC-DC converter 50 is an overcurrent, the resonant driving unit 210 may interrupt driving by receiving a fault_enable (Fault_enb) as a protection signal for protecting a system and/or circuit.

Referring to FIG. 1, the switching control signal generating unit 230 of the resonance control block 200 may be configured to receive a feedback of the output of the DC-DC converter 50 and provide a switching control signal to the resonant driving unit 210. For example, referring to FIG. 2, the switching control signal generating unit 230 may receive a feedback signal from a photocoupler 57a of a feedback unit 57 connected to an output unit 55 of the DC-DC converter 50. For example, a signal is outputted through an RT terminal of FIG. 1 to the photocoupler 57a of FIG. 2, and a feedback signal of the output voltage of the DC-DC converter 50 is inputted through the photocoupler 57a to a DT terminal. In FIG. 1, a signal inputted to the DT terminal is inputted to an inverting terminal of a comparator, and an output of the comparator is connected to the DT terminal by negative feedback. Also, the output of the comparator is inputted to a dead time generator, and the output of the dead time generator is provided to a ramp generator, which generates a ramp signal, together with an output of another comparator connected to the RT terminal. An output of the ramp generator is provided to a logic driver, and an output of the logic driver is inputted to the resonant driving unit 210. The RT terminal is connected to an inverting terminal of another comparator, the output of the comparator is connected to the RT terminal and the inverting terminal, and the output of the comparator is provided to the ramp generator by negative feedback. The ramp generator receives the output of the comparator and the output of the dead time generator and provides the resulting signal to the logic driver. Herein, the ramp generator may receive a soft start (SS_START) signal and a resonance standby (LLC STANDBY) signal, may be soft-started by the SS_START signal, and may become a standby state according to the LLC STANDBY signal. Also, the ramp generator may receive a current generated from a soft start current generator. Also, the logic driver may also receive the LLC STANDBY signal, and may become a standby state according to the STANDBY signal.

Referring to FIG. 1, in an exemplary embodiment, the resonance control block 200 may further include a soft start circuit unit 250 configured to generate and provide a soft start signal to the resonant driving unit 210 when the DC-DC converter 50 is in an abnormal state. Referring to FIGS. 1 and 2, an S/S terminal of the soft start circuit unit 250 may be connected through a capacitor to the photocoupler 57a of the DC-DC converter 50. When a feedback voltage from the photocoupler 57a is 0 V, a charged voltage of the capacitor may be inputted through the S/S terminal. Referring to FIG. 1, the S/S terminal is noninverting-inputted to two comparators, and it is compared with reference voltages, for example, 0.4 V and 3.2 V inputted to an inverting terminal. Herein, a constant current source, for example, a 5 μA voltage is connected to a noninverting terminal of the comparator compared with the reference voltage 0.4 V, and another constant current source, for example, a 60 μA voltage may also be connected through the switching of the SS_START signal. Also, the comparator compared with the reference voltage 0.4 V may output the SS_START signal. In FIG. 1, the output of the comparator compared with the reference voltage 0.4 V and the output of the comparator compared with the reference voltage 3.2 V may be inputted to a NOR gate, and it may be inputted to an OR gate and outputted to the soft start current generator, to together with the output of the comparator compared with the reference voltage 0.4 V. The output of the soft start current generator may be applied to the ramp generator. Also, the SS_START signal outputted from the comparator compared with the reference voltage 0.4 V may be applied to the resonant driving unit 210, the logic driver, and the ramp generator.

Referring to FIG. 1, the resonance control block 200 may further include an overcurrent protection unit 255. The overcurrent protection unit 255 determines whether the input from the interleave switching converter 30 to the DC-DC converter 50 is an overcurrent, and protects a system and/or a circuit when the input from the interleave switching converter 30 to the DC-DC converter 50 is an overcurrent. Referring to FIG. 1, the overcurrent protection unit 255 receives an input voltage from the switching converter 30 to the DC-DC converter 50 through an OC terminal. A comparator compares it with a reference voltage (e.g., a 1.0 V/0.6 V voltage connected to an inverting terminal) and outputs an overcurrent signal. Also, it becomes a protection state by being inputted to an OR gate together with the output of an overcurrent latch. When it becomes a protection state, a protection signal may be inputted to the soft start current generator to perform a soft start. Also, when it becomes a protection state, a fault_enable (Fault_enb) signal is provided as a protection signal to the resonant driving unit 210 to interrupt a driving operation thereof.

Referring to FIG. 1, in an exemplary embodiment, the resonance and PFC integrated control IC may further include a power supply block 300.

Referring to FIG. 1, the power supply block 300 may include a power supply unit configured to supply an internal reference voltage, and an Under-Voltage Lock-Out (UVLO) unit configured to interrupt a low-voltage input of the internal reference voltage. Referring to FIG. 1, the power supply block 300 receives a reference voltage, which drives a control IC, through a VCC_P terminal. A VCC_L terminal is grounded through an external capacitor. In FIG. 1, the UVLO unit may be connected to terminals VCC_P, VCC_L, VDD and VSS_PC, and may interrupt a low-voltage input of an internal reference voltage. The UVLO unit of FIG. 1 outputs Vxx (reference voltage) that is an internal reference voltage. Also, the UVLO unit may receive a PFC_OK signal and output a PFC_STANDBY signal, a TSD signal, a bias signal, and an LLC_STANDBY signal.

Referring to FIG. 1, together with the PFC_OK signal, the PFC_STANDBY signal may be inputted as a set/reset signal to a sequential circuit (e.g., an SR flip-flop), and it may be outputted through an output terminal QB. Also, it may be inputted to an AND gate, together with a feedback voltage inputted through a VSENSE terminal and a reference voltage (e.g., 3.4 V applied to a noninverting terminal) and a signal compared and outputted by a comparator, and it may be outputted as a low-voltage protection (UVP) signal from an AND gate.

A power converter in accordance with an exemplary embodiment of the present invention will be described below in detail with reference to the drawings. Herein, the description may be made with reference to FIG. 1 illustrating the resonance and PFC integrated control IC in accordance with an exemplary embodiment of the present invention, and thus a redundant description will be omitted for conciseness.

FIG. 2 is a circuit diagram illustrating a power converter in accordance with an exemplary embodiment of the present invention. FIG. 3 is a circuit diagram illustrating a power converter in accordance with another exemplary embodiment of the present invention.

Referring to FIG. 2 and/or FIG. 3, a power converter in accordance with an exemplary embodiment of the present invention includes a bridge rectifier 20, an interleave switching converter 30, a DC-Dc converter 50, and a resonance and PFC integrated control IC 10.

Referring to FIG. 2 and/or FIG. 3, the bridge rectifier 20 may be configured to rectify an Alternating Current (AC) input. Referring to FIG. 2, a CS terminal of the resonance and PFC integrated control IC 10 may be connected to a minus terminal of the bridge rectifier 20 to sense a current flowing through the bridge rectifier 20 in the CS terminal. Referring to FIGS. 2 and 3, an output signal of the bride rectifier 20, for example, a current signal may be inputted to first and second converters 31 and 33 of an interleave switching converter 30 in a shunting manner.

The interleave switching converter 30 will be described below with reference to FIG. 2 and/or FIG. 3.

The interleave switching converter 30 includes the first converter 31 including a first switch 31a and the second converter 33 including a second switch 33, and the first converter 31 and the second converter 33 are connected in parallel. The interleave switching converter 30 may be configured to convert the output of the bridge rectifier 20 into a Direct Current (DC) voltage by the first and second converters 31 and 33. The first and second converters 31 and 33 may be alternately driven under the control of the resonance and PFC integrated control IC 10.

In an exemplary embodiment, the first and second switches 31a and 33a may be NMOS transistors.

In an exemplary embodiment, the interleave switching converter 30 may be a boost converter.

Referring to FIGS. 2 and 3, the first converter 31 may include a first inductor 31b, a first switch 31a, and a first diode, and the second converter 33 may include a second inductor 33b, a second switch 33a, and a second diode. When the first switch 31a performs an off operation, an input current of the first converter 31 is provide to an output unit 35 of the interleave switching converter 30 through the first inductor 31b and the first diode. In this case, the second switch 33a performs an on operation, an input current of the second converter 33 is grounded through the second inductor 33b and the second switch 33a, and a current does not flow in the second diode. On the other hand, when the first switch 31a performs an on operation, an input current of the first converter 31 is grounded through the first switch 31a, and a current does not flow in the first diode. In this case, the second switch 33a performs an off operation, and an input current of the second converter 33 is outputted through the second inductor 33b and the second diode. In this case, there may be a short dead time period where the first switch 31a and the second switch 33a are simultaneously off. The dead time period is only to perform smooth charge/discharge.

In FIGS. 2 and 3, an output capacitor 35a may be connected to the output unit 35 of the interleave switching converter 30 to be charged by the output of the first and second converters 31 and 33. Referring to FIG. 2 and/or FIG. 3, a division resistor for feedback of an output voltage is connected to the output unit 35 of the interleave switching converter 30, and a voltage divided by the division resistor is fed back to the resonance and PFC integrated control IC 10, for example, the VSENSE terminal, for control of the first and second switches 31a and 33a. Referring to FIG. 3, the output unit 35 of the interleave switching converter 30 includes division resistors (e.g., R13 and R14) and resistors connected thereto. A node between the R13 and R14 may be connected to a feedback terminal of the resonance and PFC integrated control IC 10, so that a division voltage corresponding to a division resistance may be fed back to the resonance and PFC integrated control IC 10.

Referring to FIG. 3, in another exemplary embodiment, the output unit 35 of the interleave switching converter 30 may further include an overvoltage protection circuit 35b configured to interrupt the application of an internal reference voltage of the resonance and PFC integrated control IC 10 when an output voltage is higher than a predetermined voltage.

Referring to FIG. 3, the overvoltage protection circuit 35b may be connected to an output division resistor of the interleave switching converter 30. Herein, the overvoltage protection circuit 35b may include a zener diode D2, a transistor Q1, and a resistor. Referring to FIG. 3, a cathode of the zener diode D2 is connected to a node of a division resistor connected to an output terminal opposite to a ground side, for example, a connection node of an output terminal side of R14, and an anode of the zener diode D2 is grounded through R11 and R12 connected in series. A driving terminal of the transistor Q1, for example, a base of a BJT is connected to a node between the R11 and R12, and a capacitor C11 is connected in parallel to R11 at the driving terminal of the transistor Q1, for example, a gate of a MOSFET or a base of a BJT. For example, a source of the MOSFET or an emitter of the BJT is grounded, and a drain of the MOSFET or a collector of the BJP is connected to the VCC supplying power to the resonance and PFC integrated control IC 10. Herein, when the output voltage of the interleave switching converter 30 is high, the resonance and PFC integrated control IC 10 may detect an overvoltage by a signal fed back to the resonance and PFC integrated control IC 10 through the output division resistor and operate in a protection mode. Even if the protection mode of the resonance and PFC integrated control IC 10 is not normally operated, when a voltage hither than a threshold voltage (Vth) is applied to the driving terminal of the transistor Q1, for example, a gate of the MOSFET or a base of the BJT according to an increase in the output voltage of the interleave switching converter 30, the transistor Q1 is driven and a current flows from a drain of the MOSFET or a collector of the BJT to a source of the MOSFET or an emitter of the BJT. Also, the voltage of a collector of the BJT or a drain of the MOSFET connected to the VCC supplying power to the resonance and PFC integrated control IC 10 becomes equal to the ground connected to a source of the MOSFET or an emitter of the BJT. Accordingly, the VCC supplying power to the resonance and PFC integrated control IC 10 becomes 0 V. Thus, the operation of the resonance and PFC integrated control IC 10 stops and the operation of the control IC and/or the interleave switching converter 30 also stops.

In general, a PFC control circuit has an overvoltage protection circuit that receives a feedback of an output voltage and performs a latch operation in the event of an overvoltage. When a PFC control IC malfunctions and fails to detect an overvoltage at a feedback terminal, the PFC control IC continuously operates and the output voltage continuously increases, which may cause a serious damage to peripheral parts. There is therefore a need to protect the peripheral parts from an overvoltage even in the event of a malfunction of the PFC control IC.

In accordance with this embodiment, when an overvoltage higher than a predetermined voltage, for example, a rated voltage is outputted through the interleave switching converter 30, an operation voltage supply to the resonance and PFC integrated control IC 10 is interrupted regardless of the normality/abnormality of the PFC control unit. This can prevent the damage of various parts of the resonance and PFC integrated control IC 10, thus making it possible to improve the product reliability.

Referring to FIG. 3, in an exemplary embodiment, the output unit 35 of the interleave switching converter 30 may further include a discharge circuit 35c configured to discharge a charged voltage of the output capacitor 35a when the internal reference voltage of the resonance and PFC integrated control IC 10 is off.

Referring to FIG. 3, the discharge circuit 35c may be connected in parallel to the output capacitor 35a of the interleave switching converter 30, and may include a transistor and a discharge resistor. A transistor S1 may perform a high-speed switching operation in a powered-off mode, and the charged voltage of the output capacitor 35a may be discharged through a discharge resistor R5 connected in series to the transistor. Referring to FIG. 3, a comparator may be connected to a gate of the transistor S1. In a powered-off mode, the comparator may receive an input signal and provide a driving signal to a gate of the transistor S1. Referring to FIG. 3, a resistor R2 grounded to a resistor R1 of an input signal line is connected to a noninverting terminal of the comparator to apply a voltage V1 according to an input signal. Also, a resistor R3 is connected between the input signal and the noninverting terminal of the comparator, and a resistor R4 is connected in parallel to a capacitor C2 having one side grounded.

In general, a smoothing capacitor is disposed at a rear end of a PFC circuit. However, because this large-capacity capacitor has a certain charged voltage even in a powered-off mode, it may cause an electric shock when a user contacts the product.

In accordance with this embodiment, a charged voltage of the output capacitor 35a of the interleave switching converter 30 is discharged in a powered-off mode. This can prevent an electric shock even in case of contact with the powered-off product, thus making it possible to improve the product reliability.

The DC-DC converter 50 will be described below with reference to FIG. 2 and/or FIG. 3.

The DC-DC converter 50 includes third and fourth switches 51a and 51b configured to receive a DC power output from the interleave switching converter 30, performs an alternate switching operation, and output the same at a resonant frequency. The third and fourth switches 51a and 51b may be at least a portion of a switching unit 51 of the DC-DC converter 50. FIG. 3 illustrates a switching unit 51 of the DC-DC converter 50 that includes only third and fourth switches 51a and 51b. FIG. 3 illustrates a switching unit 51 of the DC-DC converter 50 that includes third and fourth switches 51a and 51b and a switching transformer 51c.

Referring to FIG. 2, in an exemplary embodiment, the switching unit 51 of the DC-DC converter 50 may include third and fourth switches 51a and 51b and a switching transformer 51c. The switching transformer 51c may be configured to receive a control signal of the resonance control block 200 of the resonance and PFC integrated control IC 10 at a primary side thereof, provide an output to the third switch 51a as a first secondary output, and provide an output to the fourth switch 51b as a second secondary output having the opposite phase to the first secondary output.

Referring to FIG. 2 and/or FIG. 3, the DC-DC converter 50 may include a transformer 53 configured to convert an output signal of the third and fourth switches 51a and 51b into a DC signal.

In an exemplary embodiment, the DC-DC converter 50 may be a resonant LLC converter. Referring to FIG. 2, a resonant LLC converter 53 is illustrated. A resonance occurs between an inductor, a leakage inductance of the transformer 53, and a capacitor, and the input of the primary side is converted into the output of the secondary side.

Referring to FIG. 2, the output unit 55 of the DC-DC converter 50 includes a diode configured to rectify the secondary side output and a capacitor configured to charge the secondary side output. Also, a feedback unit 57 for feedback of the output voltage of the resonance and PFC integrated control IC 10 is connected to the output unit 55 of the DC-DC converter 50. The feedback unit 57 of the DC-DC converter 50 includes a photocoupler 57a, and provides a feedback signal to the resonance control block 200 of the resonance and PFC integrated control IC 10. For example, referring to FIG. 1, the output of the DC-DC converter 50 may be fed back through the RT and DT terminals.

The resonance and PFC integrated control IC 10 will be described below with reference to FIGS. 1, 2 and 3.

The resonance and PFC integrated control IC 10 of the power converter in accordance with this embodiment includes an interleave PFC control block 100 and a resonance control block 200. Referring to FIG. 1, the interleave PFC control block 100 is configured to control first and second switches 31a and 33a of an interleave switching converter 30 and correct a power factor.

The resonance control block 200 is configured to control third and fourth switches 51a and 51b of a DC-DC converter 50 to be alternately switched at a resonant frequency.

Referring to FIG. 1, in another exemplary embodiment, the interleave PFC control block 100 of the resonance and PFC integrated control IC 10 may include a PFC driving unit 110, a zero-cross detecting unit 130, an interleave signal generating unit 140, and a PWM control signal generating unit 120. Referring to FIG. 1 and/or FIG. 2, the PFC driving unit 110 is configured to drive the first and second switches 31a and 33a of the interleave switching converter 30. The zero-cross detecting unit 130 is configured to detect a zero-cross of power flowing in a first inductor 31b of a first converter 31 and a second inductor 33b of a second converter 33. The interleave signal generating unit 140 is configured to receive the output of the zero-cross detecting unit 130 and generate an interleave signal to allow the PFC driving unit 110 to control the first and second switches 31a and 33a. The PWM control signal generating unit 120 is configured to receive a feedback of the output of the interleave switching converter 30, determine a PWM duty ratio, and provide the determined PWM duty ratio to the PFC driving unit 110. A more detailed description thereof will be omitted for conciseness.

Referring to FIG. 1, in an exemplary embodiment, the resonance control block 200 of the resonance and PFC integrated control IC 10 may include a resonant driving unit 210 and a switching control signal generating unit 230. Referring to FIG. 1 and/or FIG. 2, the resonant driving unit 210 of the resonance control block 200 is configured to control an alternate switching of third and fourth switches 51a and 51b of the DC-DC converter 50 to input the output of the interleave switching converter 30 into a transformer 53 at a resonant frequency. The switching control signal generating unit 230 is configured to receive a feedback of the output of the DC-DC converter 50 and provide a switching control signal to the resonant driving unit 210. A more detailed description thereof will be omitted for conciseness.

As described above, according to the embodiments of the present invention, an interleave PFC circuit and a resonant converter control circuit are integrated into one chip, thus making it possible to reduce the number of parts, cut costs, and reduce the product size.

The integration of the circuits into one chip makes it possible to solve the problems of high packing cost and large package size, reduce a noise caused by the interconnection, and reduce an interference caused by the separation of signal lines.

Also, it is possible to provide an improved power converter having ICs integrated into one chip.

Also, when an overvoltage higher than a rated voltage is outputted through a PFC circuit, an improved power converter according to an exemplary embodiment of the present invention interrupts an operation voltage supply to a PFC control unit regardless of the normality/abnormality of the PFC control unit. This can prevent the explosion or damage of various parts of the PFC circuit, thus making it possible to improve the product reliability.

Also, an improved power converter according to another exemplary embodiment of the present invention is provided to discharge a charged voltage of a PFC capacitor in a powered-off mode. This can prevent an electric shock even in case of contact with the powered-off product, thus making it possible to improve the product reliability.

It will be apparent that various other effects can be derived from various configurations of the embodiments of the present invention by those skilled in the art.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A resonance and Power Factor Correction (PFC) integrated control Integrated Circuit (IC), which comprises:
an interleave PFC control block configured to control first and second switches of an interleave switching converter and correct a power factor, wherein the interleave switching converter comprises a first converter comprising the first switch and a second converter comprising the second switch, and the first converter and the second converter are connected in parallel; and
a resonance control block configured to resonate and control a Direct Current (DC)-DC converter that receives and converts the output of the interleave switching converter.

2. The resonance and PFC integrated control IC according to claim 1, wherein the interleave PFC control block comprises:
a PFC driving unit configured to drive the first and second switches;
a zero-cross detecting unit configured to detect a zero-cross of power flowing in a first inductor of the first converter and a second inductor of the second converter;
an interleave signal generating unit configured to receive the output of the zero-cross detecting unit and generate an interleave signal to allow the PFC driving unit to control the first and second switches; and
a Pulse Width Modulation (PWM) control signal generating unit configured to receive a feedback of the output of the interleave switching converter, determine a PWM duty ratio, and provide the determined PWM duty ratio to the PFC driving unit.

3. The resonance and PFC integrated control IC according to claim 2, wherein the PWM control signal generating unit comprises:
an error amplifier configured to compare the feedback signal of the output of the interleave switching converter with a reference voltage signal and amplify an error therebetween;
a PWM comparator configured to compare an amplified signal of the error amplifier with a reference waveform and output an on-time or off-time duty; and
a sequential circuit configured to receive the output of the PWM comparator and the output of the interleave signal generating unit and provide a PWM control signal to the PFC driving unit.

4. The resonance and PFC integrated control IC according to claim 3, wherein:
the interleave PFC control block further comprises an abnormal state detecting unit configured to detect an abnormal state of the IC or the interleave switching converter; and
the PWM control signal generating unit further comprises an OR gate configured to receive the output of the PWM comparator and the output of the abnormal state detecting unit and output the result to the sequential circuit.

5. The resonance and PFC integrated control IC according to claim 1, which further comprises a power supply block comprising:
a power supply unit configured to supply an internal reference voltage; and
an Under-Voltage Lock-Out (UVLO) unit configured to interrupt a low-voltage input of the internal reference voltage.

6. The resonance and PFC integrated control IC according to claim 1, wherein the resonance control block comprises:
a resonant driving unit configured to control an alternate switching of third and fourth switches of the DC-DC converter to input the output of the interleave switching converter into a transformer at a resonant frequency; and
a switching control signal generating unit configured to receive a feedback of the output of the DC-DC converter and provide a switching control signal to the resonant driving unit.

7. The resonance and PFC integrated control IC according to claim 6, wherein the resonance control block further comprises a soft start circuit unit configured to generate and provide a soft start signal to the resonant driving unit when the DC-DC converter is in an abnormal state.

8. A power converter, which comprises:
a bridge rectifier configured to rectify an Alternating Current (AC) input;
an interleave switching converter configured to convert the output of the bridge rectifier into a Direct Current (DC) voltage by first and second converters, wherein the interleave switching converter comprises the first converter comprising a first switch and the second converter comprising a second switch, and the first converter and the second converter are connected in parallel;
a DC-DC converter comprising third and fourth switches configured to receive the DC voltage output of the interleave switching converter, perform alternate switching, and output the result at a resonant frequency, and a transformer configured to convert the output signal of the third and fourth switches into a DC signal; and
a resonance and Power Factor Correction (PFC) integrated control Integrated Circuit (IC) comprising an interleave PFC control block configured to control the first and second switches of the interleave switching converter and correct a power factor, and a resonance control block configured to control the third and fourth switches of the DC-DC converter to be alternately switched at a resonant frequency.

9. The power converter according to claim 8, wherein the interleave PFC control block of the resonance and PFC integrated control IC comprises:
a PFC driving unit configured to drive the first and second switches;
a zero-cross detecting unit configured to detect a zero-cross of power flowing in a first inductor of the first converter and a second inductor of the second converter;
an interleave signal generating unit configured to receive the output of the zero-cross detecting unit and generate an interleave signal to allow the PFC driving unit to control the first and second switches; and
a Pulse Width Modulation (PWM) control signal generating unit configured to receive a feedback of the output of the interleave switching converter, determine a PWM duty ratio, and provide the determined PWM duty ratio to the PFC driving unit.

10. The power converter according to claim 8, wherein the resonance control block of the resonance and PFC integrated control IC comprises:
a resonant driving unit configured to control an alternate switching of third and fourth switches of the DC-DC converter to input the output of the interleave switching converter into a transformer at a resonant frequency; and
a switching control signal generating unit configured to receive a feedback of the output of the DC-DC converter and provide a switching control signal to the resonant driving unit.

11. The power converter according to claim 8, wherein the interleave switching converter is a boost converter.

12. The power converter according to claim 8, wherein the output unit of the interleave switching converter comprises an overvoltage protection circuit configured to interrupt the application of an internal reference voltage of the resonance and PFC integrated control IC when an output voltage is higher than a predetermined voltage.

13. The power converter according to claim 9, wherein the output unit of the interleave switching converter comprises an overvoltage protection circuit configured to interrupt the application of an internal reference voltage of the resonance and PFC integrated control IC when an output voltage is higher than a predetermined voltage.

14. The power converter according to claim 8, wherein the output unit of the interleave switching converter comprises a discharge circuit configured to discharge a charged voltage of an output capacitor when an internal reference voltage of the resonance and PFC integrated control IC is off.

15. The power converter according to claim 9, wherein the output unit of the interleave switching converter comprises a discharge circuit configured to discharge a charged voltage of an output capacitor when an internal reference voltage of the resonance and PFC integrated control IC is off.

16. The power converter according to claim 8, wherein the DC-DC converter is a resonant LLC converter.

17. The power converter according to claim 8, wherein:
the DC-DC converter comprises a switching unit comprising the third and fourth switches; and
the switching unit comprises a switching transformer configured to receive a control signal of the resonance control block of the resonance and PFC integrated control IC at a primary side thereof, provide an output to the third switch as a first secondary output, and provide an output to the fourth switch as a second secondary output having the opposite phase to the first secondary output.
